(19) United States
(12) Patent Application Publication
(10) Pub. No.: US 2024/0232284 A9
(43) Pub. Date: Jul. 11, 2024

(54) COLUMN-PARTITIONED SPARSE MATRIX MULTIPLICATION

(71) Applicant: HEWLETT PACKARD ENTERPRISE DEVELOPMENT LP, Houston, TX (US)

(72) Inventors: DANIEL DAUWE, Ft. Collins, CO (US); Avinash Kethineedi, Bangalore (IN); Darel Neal Emmot, Ft. Collins, CO (US); Ponnamanda Bhaskar Sampath Sai Sriram, Bangalore (IN)

(21) Appl. No.: 17/971,486

(22) Filed: Oct. 21, 2022

(51) Int. Cl. G06F 17/16

(52) U.S. Cl. CPC G06F 17/16

(57) ABSTRACT

Systems and methods implement a column-partition sparse matrix (CPSM) format that provides enhanced/efficient matrix operations, e.g., sparse matrix vector multiplication (SpMV). The CPSM format is an enhanced layout, the data being arranged by column-partitioning the sparse matrix, and partitioning the dense matrix in a manner that improves scalability, computational efficiency, and leverages distributed computing architecture in performing SpMV operations. For example, data can be arranged by partitioning, by column, one or more contiguous columns of a sparse matrix of data into a plurality of column partitions, where the sparse matrix is associated with a sparse matrix multiplication operation. A plurality of column partition groups is formed. Each of the plurality of column partition groups are then distributed to a respective processor from a plurality of processors such that a portion of the sparse matrix multiplication operation is independently performed by each processor of the plurality of processors.

### BACKGROUND

A sparse matrix (also referred to as a sparse array) is a data structure in which most of the elements of the matrix are zero. Sparse matrices are often used in computational domains where the concept of sparsity is applicable, such as network theory, numerical analysis, and scientific computing, which typically have a low density of significant data or connections. For example, sparse matrices can be useful for large-scale applications where dense matrices are intractable, as in solving partial differential equations. Sparse matrix-vector multiplication (SpMV) is a mathematical operation that is often used in scientific and engineering applications that involves the matrix multiplication of one or more sparse matrices. SpMV is a fundamental kernel that is employed in high performance computing, machine learning, and scientific computation; and is also utilized heavily used in graph analytics. Furthermore, SpMV is often considered as a building block for many other computational algorithms such as graph algorithms, graphics processing, numerical analysis, and conjugate gradients.

However, a single unilateral approach for formatting a sparse matrix may not be suitable for all sparse matrices (e.g., having different sparsity patterns) or most efficient for all applications that utilize sparse matrices, including SpMV. Therefore, it may be beneficial to represent a sparse matrix (e.g., the input matrix for a SpMV operation) in a manner that improves the performance of processing sparse matrices, and particularly SpMV, in order to optimize processing time and space usage on different computer platforms.

### BRIEF DESCRIPTION OF THE DRAWINGS

The present disclosure, in accordance with one or more various implementations, is described in detail with reference to the following figures. The drawings are provided for purposes of illustration only and merely depict typical or example implementations. These drawings are provided to facilitate the reader's understanding of various implementations and shall not be considered limiting of the breadth, scope, or applicability of the present disclosure. It should be noted that for clarity and ease of illustration these drawings are not necessarily made to scale.

FIG. 1 illustrates an example of data arranged in a specialized Compressed Sparse Row (CSR) layout that can be employed in performing sparse matrix-vector multiplication (SpMV) operations, in accordance with the disclosure.

FIG. 2A illustrates an example of data being restructured into a disclosed column-partitioned sparse matrix (CPSM) format that can be employed in performing SpMV operations, in accordance with the disclosure.

FIG. 2B illustrates an example of data shown in FIG. 2A continued to be restructured into the disclosed CPSM format that can be employed in performing SpMV operations, in accordance with the disclosure.

FIG. 3A illustrates an example of a computer system performing an SpMV operation using data structured in the disclosed CPSM format shown in FIG. 2B, in accordance with the disclosure.

FIG. 3B illustrates an example of a plurality of processing entities in a computer system, such as the computer system shown in FIG. 3A, processing data structured in the disclosed CPSM format, in accordance with the disclosure.

FIG. 4 is an operational flow diagram illustrating an example method for implementing column-partitioning aspects for reorganizing data into the CPSM format, in accordance with the disclosure.

FIG. 5 is an operation flow diagram illustrating an example method for implementing a prefetching associated with an SpMV operation of data in the disclosed CPSM format, in accordance with the disclosure.

FIG. 6 is an operation flow diagram illustrating an example method for implementing compute processing associated with an SpMV operation using data in the disclosed CPSM format, in accordance with the disclosure.

FIG. 7 is an operation flow diagram illustrating an example method for implementing a result accumulation associated with a SpMV operation of data in the disclosed CPSM format, in accordance with the disclosure.

FIG. 8 depicts a block diagram of an example computer system in which various of the implementations described herein may be implemented.

The figures are not intended to be exhaustive or to limit various implementations to the precise form disclosed. It should be understood that various implementations can be practiced with modification and alteration.

### DETAILED DESCRIPTION

Sparse matrix-vector multiplications (SpMV) are widely used for many scientific computations, such as graph algorithms, graphics processing, numerical analysis, and conjugate gradients. The performance and efficiency of SpMV are greatly affected by the sparse matrix representation utilized. The disclosed embodiments provide a distinct column-partitioned formatting to represent the sparse matrix, which improves cache utilization, improves scalability, reduces latency, and leverages the advantages of distributed computer processing particularly for SpMV calculations.

As referred to herein, a sparse matrix is a matrix in which a large number (e.g., majority) of the elements within the matrix are zero. Thus, sparse matrices have very few non-zero values spread throughout. By contrast, if most of the elements of the matrix are non-zero, then the matrix is considered a dense matrix. In many computing platforms, processing a large sparse matrix, with few non-zero values, is inefficient due to the suboptimal overhead in space usage and computational processing associated with the many non-zero values. These aforementioned drawbacks related to sparse matrices are motivating continued development of specialized data layouts (or formats) and algorithms for efficiently transferring and manipulating the data in manner that leverages the advantages of the sparse structure of the sparse matrix.

The sparsity of a matrix is defined as the number of non-zero elements (NZ) divided by number rows in the matrix. As used herein, the term sparsity is not limited to the abovementioned definition and also can be a reference to a more conceptual sparsity of a matrix. Sparse Matrix Vector Multiplication (SpMV) benchmarks a function that is represented below mathematically as:

Y=Ax (1)
where A is a sparse matrix, and
x and Y are dense column vectors (DCMV and DCRV respectively)

There are several traditional approaches for representing a sparse matrix utilizing a more efficient layout (or format) to address the problems associated with sparse matrices (e.g., processing and space inefficiencies). Examples of specialized layouts for a sparse matrix that are conventionally used include but are not limited to: Compressed Sparse Row (CSR); Compressed Sparse Column (CSC); Block Sparse Row (BSR); and the like. Although these conventional layouts for a sparse matrix, such as CSR, can be parallelized, these layouts are still subject to limitations, bottlenecks, and inefficiencies that prevent efficient scalability even when implemented across a distributed computing platform. For instance, the CSR layout may experience scalability problems as the system and problem sizes increase. For example, in the CSR layout it can be difficult to partition groups of rows such that processing entities (PEs) have the same number of transfers (e.g., transfers of data during computational processing). Additionally, there are other considerations associated with the CSR layout, including: the row index vector must be parsed to discern how many non-zero values; which values of the x-dense column vectors that will be needed cannot be determined a priori; and the entire x-vector is typically read, which is an extra pressure on the PE memory capacity. In order to address these and other drawbacks associated with traditional layouts, the disclosed embodiments include an enhanced specialized layout for representing a sparse matrix, referred to as a column-partition sparse matrix. The column-partition sparse matrix (CPSM), which is described in greater detail herein, provides improvements over the aforementioned traditional layouts. Particularly, the disclosed CPSM format is an enhanced layout that can be used for matrix operations, where the data is distinctly arranged by column-partitioning the sparse matrix and partitioning the dense matrix in a manner that improves scalability and computational efficiency when performing sparse matrix vector multiplication (SpMV).

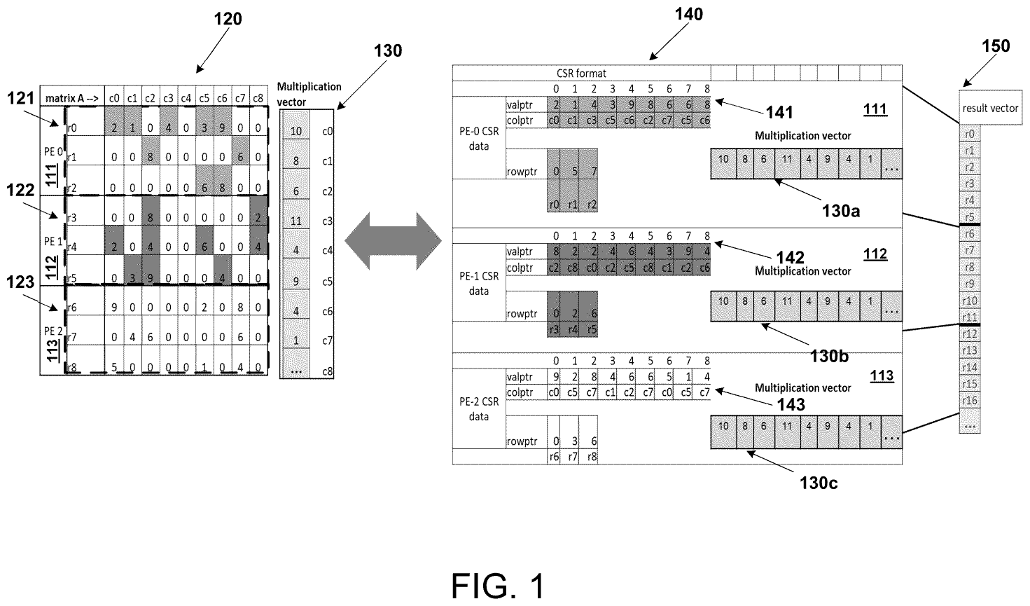

Referring now to FIG. 1, an example of data arranged in a specialized layout, namely a CSR layout 140 that can be used in an SpMV operation is depicted. In the illustrated example, the data in the CSR layout can be utilized in a SpMV benchmark operation that is represented in Eq. 1 above, between an example sparse matrix 120 and an example dense column multiplier vector (DCMV) 130 in order to derive the resulting dense column result vector (DCRV) 150. The benchmark operation (shown in Eq. 1) illustrates a common mathematical operation involving sparse matrices, where a sparse matrix is multiplied by a dense matrix. In such an operation, the result is the dot-product of each sparse row of the matrix with the dense vector which results in a dense vector. In other words, multiplying a sparse vector by a dense vector will have a dot-product result of another dense vector. Accordingly, the data in FIG. 1 depicts this benchmark operation, showing a sparse matrix, namely sparse matrix 120, being multiplied by a dense matrix, namely DCMV 130, which results in a dense matrix as the product of the multiplication, namely DCRV 150. As alluded to above, data organized in the CSR layout, as shown in FIG. 1, can be leveraged for distributed and parallel processing of the SpMV benchmark operation executed by a computer system (e.g., data in the CSR layout distributed across a plurality of PEs of the computer system). As referred to herein, the DCMV is a dense vector, being a matrix that has a large number (e.g., majority) of non-zero elements, which is the multiplier for a sparse matrix in a matrix multiplication operation. As referred to herein, the DCRV is a dense vector which is the resulting product of a matrix multiplication operation involving a sparse matrix and a DCMV.

Initially (e.g., prior to arranging data of the sparse matrix 120 and DCMV 130 into the CSR layout), FIG. 1 shows that the sparse matrix 120 can be separated into multiple smaller sections that include a portion of the elements that comprise the entire sparse matrix 120. These sections are referred to herein as partitions 121-123 (indicated in FIG. 1 by dashed boxes) of the sparse matrix 120, where each of the partitions 121-123 includes a respective number of rows and columns of the sparse matrix 120. In the example, each of the partitions 121-123 comprise a 3 (rows)×9 (columns) matrix, where the original sparse matrix 120 is a 9×9 matrix. For instance, when a computer system is executing a SpMV operation, the partitions 121-123 can be distributed across several PEs of the computer system, such that each partition 121-123 is local to a corresponding one of the PEs. Particularly, the example of FIG. 1 illustrates PE 111 (shown in FIG. 1 as “PE0”), PE 112 (shown in FIG. 1 as “PE1”), and PE 113 (shown in FIG. 1 as “PE2”) that can be included in the architecture of a computer system. Further, FIG. 1 particularly depicts that the partition 121 resides on PE 111, partition 122 resides on PE 112, and partition 123 resides on PE 113. Thus, each of the PEs 111-113 hold a corresponding one of the partitions 121-123 of sparse matrix 120, respectively.

Moreover, the sparse matrix 120 can be re-formatted in accordance with a traditional layout in order to realize some improved efficiency as previously described. In the example of FIG. 1, the sparse matrix 120 is reformatted in accordance with the traditional CSR layout which restructures the elements of the sparse matrix 120 and the DCMV 130 into the CSR layout data 140. The CSR layout data 140 is similarly structured based on partitions 121-123. Accordingly, the CSR layout data 140 is also sectioned into partition blocks 141-143 (respectively corresponding to partitions 121-123) and distributed across the PEs 111-113. As shown in FIG. 1, partition 141 of the CSR layout data 140 is locally stored on PE 111, partition 142 of the CSR layout data 140 is locally stored on PE 112, and partition 143 of the CSR layout data 140 is locally stored on PE 113.

In addition, FIG. 1 shows that the CSR layout data 140 is structured using the traditional CSR layout approach to compress the original sparse matrix 120 such that the non-zero matrix elements from each of the partitions 121-123, are represented as an element value, column value, and row value, within an associated partition 141-143 of the CSR layout data 140. That is, partition 141 of the CSR layout data 140 represents the non-zero matrix elements from the partition 121, partition 142 of the CSR layout data 140 represents the non-zero matrix elements from the partition 122, and partition 143 of the CSR layout data 140 represents the non-zero matrix elements from the partition 123. Consequently, the SpMV computation can be performed by processing the CSR layout data 140 (which is a compressed representation of all the elements contained in sparse matrix 120) as opposed to processing all the zero and non-zero elements of the original sparse matrix 120 which has unnecessary overhead.

In operation, the cores of each PE 111-113 can parallelize decoding and processing sparse matrix 120 structure, multiply-accumulating elements of the DCRV 150, and writing elements of the DCRV 150 as each row completes. As one of the partitions 121-123 of the sparse matrix 120 is processed by the corresponding PE's 111-113 processing core, the next of the partitions 121-123 can be prefetched from an external memory of the system (not shown) to improve execution efficiency. Because the computing system processes the larger sparse matrix 120 as smaller partition blocks 121-123, as each partition 121-123 is completed the corresponding partial DCRV 150 can be sent back to the external memory. Processing for the SpMV benchmark operation continues until all of the partition blocks 121-123 have been processed and the final result of the SpMV operation, which is the full DCRV 150, is generated and stored.

The structure of the CSR layout data 140 strongly influences processing (e.g., while performing the SpMV computation) to progress sequentially through columns for each sequential row, respectively for each of the partitions 141-143 within the CSR layout data 140. The sparsity of non-zero columns in a row provides no expectation of which elements in the DCMV 130 need to be used at any given time during the SpMV computation. Consequently, while the sparse matrix 120 and the DCRV 130 does achieve some efficiency in being partitioned across the system, the entire DCMV 130 needs to be distributed to every endpoint PE and persist at every endpoint PE for the multiply-accumulate operations to proceed in the order that the matrix values are accessed. Also, FIG. 1 illustrates that the SpMV algorithm cannot begin computation utilizing the CSR layout data 140 until the DCMV 130 is entirely distributed to all of the PEs 111-113. As seen in FIG. 1, an instance of the DCMV 130 is replicated within the CSR layout data 140 at each of the processing entities 111-113. Particularly in the example, the CSR layout data 140 includes DCMV 130a that locally resides on PE 111 as an instance of the DCMV 130. The CSR layout data 140 also includes DCMV 130b that locally resides on PE 112 as another instance of the DCMV 130. Additionally, the CSR layout data 140 includes DCMV 130c that resides on PE 113 as yet another instance of the DCMV 130.

Thus, there is a full data representation of the DCMV 130 stored respectively at each of the PEs 111-113 as a portion of the SpMV computation that is also distributed to each of the PEs 111-113 to be performed in parallel. However, sparsity of the sparse matrix 120 implies that there will be a low probability of reuse for recently cached cache lines that contain multiple adjacent data from the respective DCMVs 130a-130c. For example, there is a low probability that each of the elements within the DCMV 130a will be reused for the specific SpMV computations executed on PE 111 (corresponding to the sparse matrix elements in the CSR layout data 140 on PE 111), which leads to cache misses during processing at the PE 111. This potential for cache misses also corresponds to the distributed processing at the other PEs, as data that may be needed for a specific computation on a PE, such as PE 111, may be currently stored on another PE that is executing its portion of processing. Thus, it can be assumed in the example of FIG. 1 that PEs 112, 113 also experience cache misses during their locally performed SpMV computations. In turn, large-scale SpMV computations that may be distributed over a larger computing platform (e.g., having a greater number of PEs) can exacerbate cache misses. For instance, the number of cache misses that may be experienced during computational processing can increase as the problem size increases and the sparsity of the sparse matrix increases. Consequently, the time spent on computation per element of the sparse matrix 120 with the traditional CSR layout is expected to increase with the problem size and sparsity, due to latency (e.g., associated with cache misses) and bandwidth utilization to higher level caches and local memory.

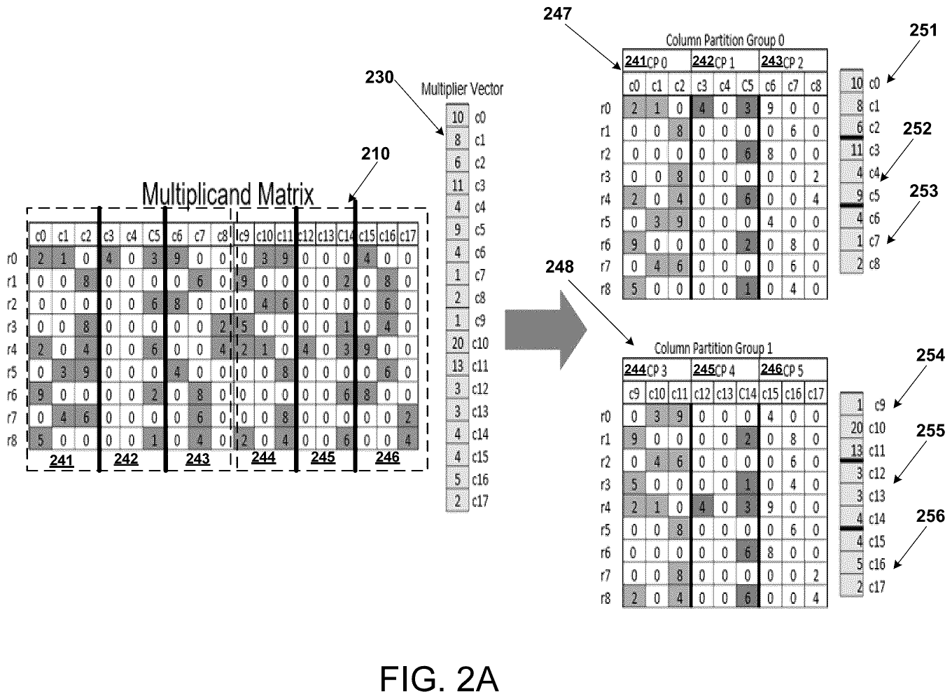

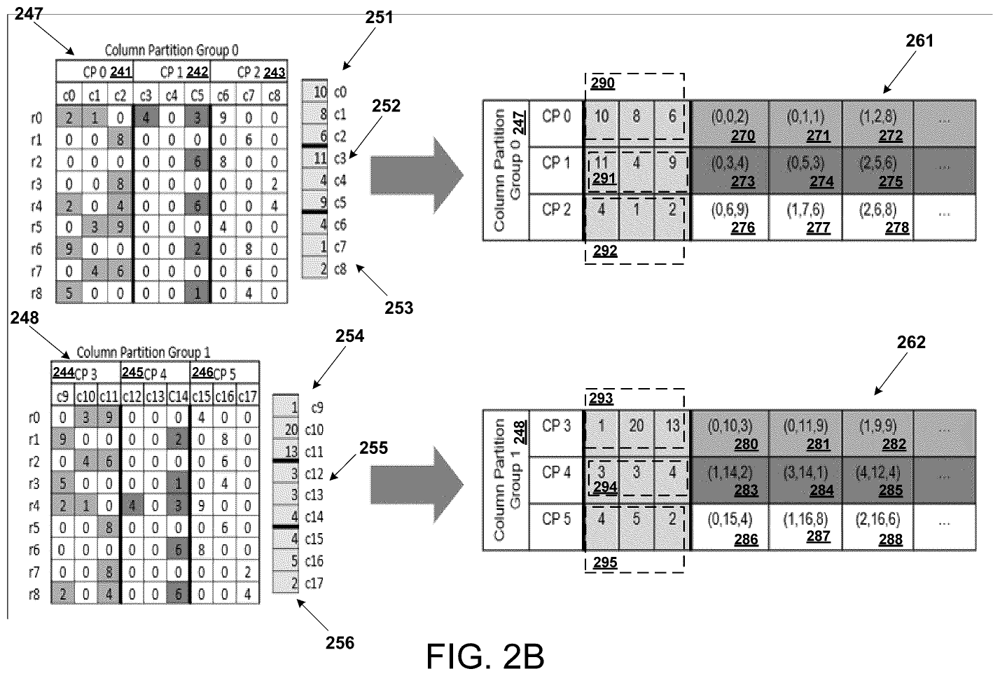

The disclosed column-partition sparse matrix (CPSM) format, as described in greater detail in reference to FIGS. 2A-2B, is optimized to overcome limitations of traditional sparse matrix layouts, such as the aforementioned latency and inefficiency issues associated with the conventionally used CSR layout. As will be laid bare in describing the disclosed embodiments, the CPSM format and corresponding modified SpMV algorithm have several benefits over the traditional baseline, including, but not limited to: improved scalability; improved speed and efficiency in transitioning between variable numbers of PEs; more efficient cache utilization; and optimized distribution of non-uniform matrix data among PEs.

FIGS. 2A-2B are conceptual illustrations of a process to reorganize data from a sparse matrix 210 that is initially arranged in a conventional M×N sparse matrix format into a plurality of column partitions and column partition groups that serve as the building blocks for the specialized CPSM format disclosed herein. The CPSM format, which is depicted in FIG. 2B, enables partitioning of both the sparse matrix 210 and the DCMV 230 that are involved in a SpMV operation. Stated another way, the disclosed CPSM format allows the sparse matrix 210 and the DCMV 230 to be partitioned into smaller groups (or blocks) of data that can be individually distributed across multiple PEs in a computer system in order to achieve a more scalable and optimized parallel processing for SpMV calculations. The disclosed CPSM format is distinctly structured to be optimized for improved scalability and computational efficiency particularly for SpMV computations. As a result, the disclosed embodiments overcome the inefficiencies and limitations associated with performing SpMV operations on an entire sparse matrix and/or a sparse matrix arranged in one of the aforementioned conventional layouts, such as the CSR layout shown in FIG. 1. Although the disclosed embodiments are described in reference to SpMV operations, the examples are not intended to be limited and the systems and techniques disclosed herein can be suitable for various other types of matrix-based operations.

In the example of FIG. 2A, the sparse matrix 210 is structured as a 9×18 sparse matrix having an arbitrary pattern of non-zero elements, and the DCMV 230 is structured as an 18×1 dense matrix. According to the embodiments, the sparse matrix 210 and the DCMV 230 are operands in a SpMV operation, in which the sparse matrix 210 is multiplied by the DCMV 230. Stated another way, the sparse matrix 210 is the multiplicand matrix and the DCMV 230 is the multiplier matrix in the SpMV operation. The result of a SpMV calculation can be described as the dot-product of each row of the sparse matrix 210 with the column of the dense vector, shown as DCMV 230.

As previously described, storing all the elements (e.g., majority of which are zero elements) of a sparse matrix can lead to a wastage of resources, such as processing and memory. Accordingly, reorganizing the sparse matrix 210 into the CPSM format involves initially partitioning the sparse matrix 210 based on columns in a manner that reduces the amount of data that is distributed to each PE for parallelized processing. As illustrated in FIG. 2A, the reformatting process starts by partitioning, or dividing, the elements of the sparse matrix 210 by column into separate smaller blocks (also referred to herein as column partitions) of data. In the example of FIG. 2A, the sparse matrix 210 is divided into six separate column partitions 241-246 (indicated in FIG. 2A by dashed-line box), where each column partition includes elements from three consecutive columns of the sparse matrix 210. As seen, the column-partitioning aspects of reorganizing the sparse matrix 210 results in: column partition 241 which includes columns c0-c2 of sparse matrix 210; column partition 242 which includes columns c3-c5 of sparse matrix 210; column partition 243 which includes columns c6-c8 of sparse matrix 210; column partition 244 which includes columns c9-c11 of sparse matrix 210; column partition 245 which includes columns c12-c14 of sparse matrix 210; and column partition 246 which includes columns c15-c17 of sparse matrix 210. Thus, column-partitioning, as disclosed herein, comprises dividing a sparse matrix into several smaller and separate column partitions, where each column partition includes a number of columns from the original sparse matrix that range from 0 to N−1 (for a M×N sparse matrix) that are allowable in accordance with a defined size for the column partitions. The number of columns (or number of non-zero elements) that are included in a single column partition block is referred to herein as the column range or the size of the column partition.

In an example, the size for each column partition (or column range) is a defined static parameter, for example being defined prior to deployment of the computer system, where the parameter is based on the specifications for one or more of the computer's resources. In an embodiment, the size of a column partition is a defined as a function of a L2 cache size utilized by the computer system (or a PE) in order to reduce the number of cache misses experienced during computational processing. In some cases, the size for a column partition can be defined using a mathematical relationship with respect to the L2 cache size, such as a percentage, rate, magnitude, fraction, factor, multiple, amount, proportion, or other quantifiable relationship/algorithm. For example, the computer system implementing the sparse matrix 210 can have a predefined default L2 cache size of 8 MB that is utilized for each of the PEs in the system. Thus, the size for the column partitions 241-246 is defined as a static parameter that is set with respect to the known L2 cache size of the PEs, for instance being approximately 800 KB which is quantifiably a factor of 10 smaller than the default cache L2 size. Generally, the defined size for a column partition may increase proportionally to the L2 cache size used by the computer system, where column partitions of a smaller size may be more optimal for substantially smaller cache sizes (e.g., 4 MB cache) and column partitions of a larger sizer may be more optimal for substantially large L2 cache sizes (e.g., 128 MB cache). The defined size for the column partitions may be based on other specifications or characteristics of the various resources of the computer system implementing the SpMV (or other matrix operations/algorithms) in addition to (or in lieu of) the L2 cache size, such as processor speed, memory size, clock speed, L1 cache size, L3 cache size, number of PEs dedicated for compute processing, and the like.

Alternatively, the size for column partitions can be a dynamic parameter, for instance being selected at run-time by the computer system. As an example, utilizing dynamic sizing for column partitions may be suitable in scenarios where sparsity of individual columns is found to have significant variance relative to the overall matrix sparsity. In this case, dynamically allocating a variable number of columns to each respective partition can allow the total number of non-zero elements in each partition to be nearly equal. Thus, as a dynamic parameter, the column partition size can be based on variables that may change substantially for different SpMV operations, such as: the size of a sparse matrix; size of the dense vector; sparsity of the sparse matrix; sparsity of the individual columns of the sparse matrix; complexity of the problem (e.g., 2ⁿ matrix scaling factor); total data transferred, and the like. Moreover, in some embodiments, all of the column partitions have a uniform size (e.g., sizes for each of the column partitions are the same/equal). In some embodiments, the size can vary amongst multiple column partitions, where each column partition that is derived from dividing a sparse matrix has its own respective size (which may be different than the sizes of the other column partitions). For example, it may be desirable for column partitions to be similar in size whereas the distribution of non-zero values may be non-uniform. The overhead to encode non-sequential columns may be acceptable to achieve aggregation of columns with similar number of non-zero elements.

As previously described, another distinct aspect of the approach to reorganize a sparse matrix into the CPSM format involves also partitioning the dense multiplier vector (shown as the DCMV 230). In contrast to other conventional sparse matrix layouts where the full dense vector is replicated at every PE involved in the SpMV operation (e.g., CSR layout), restructuring data into the disclosed CPSM format also includes partitioning the dense vector in addition to column-partitioning the sparse matrix. Accordingly, FIG. 2A illustrates that the DCMV 230 is partitioned into six separate blocks 251-256 (also referred to herein as vector partitions) that contain elements from the DCMV 230. A vector partition can be considered as a smaller subset block of contiguous elements, by row, from the original DCMV. Restated, the dense vector is row-partitioned into smaller separate vectors, where each partition vector has fewer rows as the full DCMV.

In the embodiments, the number of distinct blocks, or vector partitions, that are generated from partitioning the dense vector is based on the number of column partitions that are available. Restated, the dense vector is separated into a number of vector partitions such that each vector partition has a corresponding column partition, where the vector partitions and column partitions can be distributed to all of the PEs in the computer system that are dedicated to computer processing. Specifically, in the example of FIG. 2A, there are six column partitions 241-246, thus there are similarly six vector partitions 251-256. As seen in FIG. 2, the vector partitions are formed by: partitioning rows c0-c2 from the original DCMV 230 into vector partition 251; partitioning rows c3-c5 from the original DCMV 230 into vector partition 252; partitioning rows c6-c8 from the original DCMV 230 into vector partition 253; partitioning rows c9-c11 from the original DCMV 230 into vector partition 254; partitioning rows c12-c14 from the original DCMV 230 into vector partition 255; and partitioning rows c15-c17 from the original DCMV 230 into vector partition 256. In an embodiment, the number of vector partitions may be based on other CPSM format-based parameters, specifications, or characteristics of the various resources of the computer system implementing the SpMV (or other matrix operations/algorithms) in addition to (or in lieu of) the number of PEs, such as processor speed, memory size, clock speed, L1 cache size, L2 cache size, L3 cache size, number of column partitions, size of column partitions, and the like.

In the example of FIGS. 2A-2B, the SpMV operation is intended to be distributed across multiple PEs in the computer system to enable parallelized compute processing. As alluded to above, the number of vector partitions will be equal to number of column partitions available, and the multiple PEs of the computer system will gather the vector partitions depending on the column partitions that the respective PE is processing. For example, if a PE is processing column partitions 241-243, shown as column partition group 247 (which is described in greater detail below), then that PE will also gather vector partitions 251-253 which includes rows of the DCMV 230 that correspond (with respect to performing the SpMV operation) to the columns of the sparse matrix 210 that comprise the column partitions 241-243. Continuing with this example, another PE that is processing column partitions 244-246, shown as column partition group 248 (which is described in greater detail below), then that PE will also gather vector partitions 254-256 which includes rows of the DCMV 230 that correspond (with respect to performing the SpMV operation) to the columns of the sparse matrix 210 that comprise the column partitions 244-246 In an embodiment, the number of PEs in the system that are dedicated to compute processing (e.g., PEs used for compute processing) is n, where n is the total number of PEs in the computer system, thus allowing the sparse matrix 210 (vis-à-vis column partitions 241-246) and the DCMV 230 (vis-à-vis vector partitions 251-256) to be distributed across all of the PEs available in the computer system in a scalable and efficient manner. Further, the number of rows from the original DCMV that are included in each vector partition can be a function of the number of rows in the original DCMV. For example, referring to FIGS. 2A-2B, because the DCMV 230 is partitioned into six separate vector partitions 251-256 (corresponding to the six column partitions 241-246 that are available) each partition 251-256 includes a function (e.g., ⅙) of the number of rows from the original DCMV (e.g., a function of the number of rows of the DCMV divided by the number of vector partitions). Restated, each of the six vector partitions 251-256 includes three rows from the original DCMV 230, which has 18 rows total.

Particularly, in FIG. 2A, the DCMV 230 is initially an 18×1 matrix and is partitioned into six vector partitions 251-256 that are structured as 3×1 vectors. As seen, a first grouping of vector partitions 251-253 (corresponding to column partition group 247) comprises rows c0-c8 from DCMV 230, and a second grouping of vector partitions 254-256 comprises rows c9-c17.

Additionally, FIG. 2A illustrates that the approach to derive the disclosed CPSM format further involves grouping some of the previously formed column partitions 241-246 into distinct column partition groups 247, 248. In the example of FIG. 2A, column partitions 241, 242, and 243 are clustered into column partition group 247, and column partitions 244, 245, and 246 are clustered into column partition group 248. Column partition groups can be considered as a collection of multiple contiguous, by column, column partitions, where each column partition group consists of a monolithic block of elements (that is a still a subset of the larger sparse matrix) that can be transferred to a PE. It should be understood that each column partition group includes one or more full columns from the original sparse matrix, but only partially includes a row from the original sparse matrix. Stated another way, the elements from an entire row of the sparse matrix are partitioned across multiple column partitions and/or column partition groups. According to an embodiment, the number of column partition groups formed (or the number of column partitions grouped together to form a single column partition group) are based on the size of the main memory of the computer system, the number vector partitions, and/or the number of PEs used for the distributed compute processing. As an example, the size of a column partition group can be represented mathematically as:

size_{CPG}<=(size_{MM})/2 (2)
where size_{CPG} is the size of the column partition group, and
size_{MM} is the size of the main memory

For instance, the column partition groups are created such that the number of column partitions 241-246, based on a size of main memory, can be distributed across all of the PEs of a computer system that are available to be utilized for compute processing of the SpMV operation. FIG. 2A depicts particularly grouping the column partitions 241-246 into two column partition groups 247, 248, which corresponds to the two PEs of a computer system that may be utilized for processing the SpMV operation. In this manner, the number of column partitions that are locally processed by a PE (e.g., three column partitions 241-243 in column partition group 247 distributed to a PE, and three column partitions 244-246 in column partition group 248 distributed to a different PE) is also the same as the number of vector partitions 251-256 that are locally processed by the respective PE (e.g., three vector partitions 251-252 distributed to a PE and three vector partitions 254-256 distributed to a different PE). Consequently, in the CPSM format, a specific column partition group is logically arranged with a corresponding grouping of vector partitions. This ensures that a tuple array, which is used in the CPSM format, includes the specific elements from the dense vector that are needed to perform a SpMV computation for each element in the column partition group (from the sparse matrix).

In an embodiment, the number of individual column partitions that are collected to form a column partition group may be based on other CPSM format-based parameters, or specifications and/or characteristics of the various resources of the computer system implementing the SpMV (or other matrix operations/algorithms) in addition to (or in lieu of), including: the size of main memory; the number of PEs in the computer system that are dedicated to compute processing; L2 cache size; such as processor speed; memory size; clock speed; L1 cache size; L2 cache size; L3 cache size; number of vector partitions; number of column partitions; and the like.

As a general description, SpMV involves dot product multiplication of an element in a row of the dense vector by each element in a column of the sparse matrix. To this point, the DCMV 230 is a N×1 matrix having a number of rows that is equal to the number of columns in the M×N sparse matrix 210, such that each row of the DCMV 230 has a corresponding column in the sparse matrix 210 for the per-element computations executed to complete the SpMV operation. In the example of FIG. 2A, the row c0 of the DCMV 230 corresponds to column c0 of the sparse matrix 210, row c1 of the DCMV 230 corresponds to column c1 of the sparse matrix 210, row c2 of the DCMV 230 corresponds to column c2 of the sparse matrix 210, and row c3 of the DCMV 230 corresponds to column c3 of the sparse matrix 210, and so on. Consequently, FIG. 2A depicts column partition group 247 includes column partition 241, which contains elements from columns c0-c2 from the sparse matrix 210 as being logically arranged with vector partition 251, which contains rows c0-c2 from the DCMV 230. Also, the column partition group 247 includes the remaining column partitions 242-243 which hold the elements from the sparse matrix 210 that correspond to the elements from the DCMV 230 that are held by vector partitions 252, 253. In particular, the column partition group 247 includes columns c0-c2, c3-c5, and c6-c8 from the sparse matrix 210 which correspond to rows c0-c2 of vector partition 251, rows c3-c5 of vector partition 252, and rows c6-c8 of vector partition 253 respectively, from the DCMV 230.

Similarly, column partition group 248 includes the elements from the sparse matrix 210 that correspond to the elements from the DCMV 230 that are held by vector partitions 254-256. Referring back to the SpMV operation between sparse matrix 210 and the DCMV 230, row c9 of the DCMV 230 corresponds to column c9 of the sparse matrix 210, row c10 of the DCMV 230 corresponds to column c10 of the sparse matrix 210, row c11 of the DCMV 230 corresponds to column c11 of the sparse matrix 210, row c12 of the DCMV 230 corresponds to column c12 of the sparse matrix 210, and so on. Accordingly, FIG. 2A shows that column partition group 248 includes column partition 244, which contains elements from columns c9-c11 from the sparse matrix 210, as being logically arranged with vector partition 254, which contains rows c9-c11 from the DCMV 230. Additionally, the column partition group 248 includes the remaining column partitions 245-246 that hold the elements from the sparse matrix 210 corresponding to the elements from the DCMV 230 that are held by vector partitions 255, 256. In particular, the column partition group 248 includes columns c9-c11, c12-c14, and c15-c17 from the sparse matrix 210 which correspond to rows c9-c11 of vector partition 254, rows c12-c14 of vector partition 255, and rows c15-c17 of vector partition 256 respectively, from the DCMV 230.

Thus, as a general description, FIG. 2A illustrates three key stages in the approach to reorganize the sparse matrix 210 into the CPSM format, which include: 1) partitioning, by column, the sparse matrix 210 into smaller and separate column partitions 241-246; 2) partitioning the DCMV 230 into separate vector partitions 251-256 which depends on the size of the column partitions 241-246; and 3) grouping several of the column partitions 241-246 together to form distinct column partition groups 247, 248.

FIG. 2B continues to illustrate this approach to reorganize the sparse matrix 210 into the disclosed CPSM format, where the column partition groups 247, 248 and the vector partitions 251-256 are arranged into corresponding tuple arrays 261, 262. In detail, the tuple array 261 has data arranged to represent the elements from the column partitions 241-243 that are grouped together in column partition group 247, and the elements from the vector partitions 251-253 (which corresponds to column partitions 241-243); and the tuple array 262 has data arranged to represent the elements from the column partitions 244-246 that are grouped together in column partition group 248, and the elements from the vector partition 254-256 (which corresponds to column partitions 244-246).

The tuple arrays 261, 262 shown in FIG. 2B can be considered as examples of a finalized format for the data representing the sparse matrix 210 and the DCMV 230. In other words, the tuple arrays 261, 262 are the data structures that are ultimately transferred to the distributed PEs, where the data contained therein is utilized in the processing (e.g., processor computations) needed to execute the SpMV operation. As referred to herein, a tuple array is a data structure that is generally arranged as an array which stores a series of elements, where the elements serve as a representation of data from a sparse matrix and dense matrix for a SpMV operation. The tuple arrays that are used in the disclosed CPSM format particularly include tuples, or finite ordered lists (sequences) of values representing the non-zero elements from the sparse matrix.

Furthermore, in the CPSM format, the tuple array structures only represent those elements which are non-zero in the sparse matrix (or the column partitions) for improved scalability and efficiency. Referring again to the example of FIGS. 2A-2B, the tuple arrays 261, 262 of the CPSM format can be considered to include a compressed representation of the sparse matrix 210, by eliminating the zero elements (which is the majority of the sparse matrix) therein. Consequently, employing the disclosed CPSM format may realize performance improvements that exponentially increase as the scale/problem size/sparsity associated with the SpMV operations grows. As illustrated in the FIGS. 2A-2B, there is a substantial reduction in the amount of data that is included in the tuple arrays 261, 262 as compared to the sparse matrix 210. Thus, the CPSM format compresses and/or reduces the amount of data from the sparse matrix and the dense vector that is transferred and processed by each PE respectively.

Moreover, the disclosed CPSM format provides a distinct arrangement/representation of data in order to achieve reduced space (e.g., less consumption of cache/memory resources), more efficient cache utilization, and improved processing speed and efficiency (e.g., decreased running time, decreased per-element computation time) associated with matrix operations, such as SpMV.

As seen in FIG. 2B, tuple arrays 261, 262 include tuples 270-278 and tuples 280-288, respectively. It should be appreciated that the tuples 270-278 and tuples 280-288 illustrated in the tuple arrays 261, 262 represent only a portion of the non-zero elements that are contained in the original sparse matrix 210 for purposes of brevity. In actual operation, the tuple arrays 261, 262 of the CPSM format would include a tuple that corresponds to each non-zero element that is present in the sparse matrix 210.

FIG. 2B illustrates that the tuples 270-278 and tuples 280-288 are defined as type (row, column, value) in order to represent the non-zero elements of the sparse matrix. Referring to the example of FIG. 2B, the column partition 241 contains several non-zero elements, namely element of row r0, column c0 having a “2” value, element of row r0, column c1 having a “2” value, and element of row r1, column c2 having an “8” value. These non-zero elements within column partition 241 are represented by the tuple array 261, which is particularly arranged to represent the data corresponding to column partition group 247 and vector partitions 251-253. Specifically, these aforementioned non-zero elements are represented by tuples 270-272. As seen, tuple 270 is formatted as (0,0,2) which corresponds to element of row r0, column c0 having a “2”. Similarly, tuple 271 is formatted as (0,1,1) which corresponds to element of row r0, column c1 having a “1”, and tuple 272 is formatted as (1,2,8) which corresponds to element of row r1, column c2 having an “8” value. In this fashion, the remaining non-zero elements contained in column partitions 241-243 (of column partition group 247) are represented by other tuples within the tuple array 261. FIG. 2B shows tuples 273-275, which represent a portion of the non-zero elements within column partition 242 and tuples 276-278 which represent a portion of the non-zero elements within column partition 243. Furthermore, in this same manner, non-zero elements contained in column partitions 244-246 (of column partition group 248) are represented by tuples within tuple array 262. FIG. 2B particularly shows tuples 280-282, which represent a portion of the non-zero elements within column partition 244, tuples 283-285 which represent a portion of the non-zero elements within column partition 245, and tuples 286-288 which represent a portion of the non-zero elements within column partition 246.

In an embodiment, without departing from the scope of the disclosed invention, additional optimizations may be applicable to the CPSM format, as described herein. As previously described, processing data in the aforementioned CSC format will increase the data transferred in the communication and may also result in bad cache performance during result accumulation since there will be more partial results needs to be accumulated. In contrast, by utilizing the disclosed CPSM format, when a row in the column partition is computed, it will accumulate all the non-zero elements in that row and that partial result will be sent to the appropriate destination node for the result accumulation.

For example, in the case where matrices have a large number of rows, each column is likely to have more than one non-zero value. Rather than duplicate the column value in each tuple, enumeration of tuples down a column preferably enumerating the column value once with a count value indicating the number of corresponding non-zero values to follow, which allows each tuple to encode only row index and element value. Similarly, for some matrix operations, non-zero values are always 1. In this scenario, it may also be advantageous to utilize an encoding optimization, such that the element tuple is further reduced to encode only the row index. By applying these types of additional optimizations, the total number of bytes representing column partition groups is thus reduced, thereby improving the efficiencies that can be achieved in using the disclosed CPSM format in SpMV operations.

In accordance with the disclosed CPSM format, a tuple array (which represents the data from a column partition group) is also arranged as an array having a sequenced list, or row, of elements that correspond to each respective column partition group that is clustered in the same column partition group. Restated, the column partitions can be represented by an individual sequenced row in a tuple array. For example, FIG. 2B shows that tuples 270-272, which represent the data from column partition 241, are organized in sequential order on a row of the tuple array 261. Similarly, tuples 273-275, which represent the data from column partition 242, are organized in sequential order on a row of the tuple array 261, and tuples 276-278, which represent the data from column partition 243, are organized in sequential order on a row of the tuple array 261. In an embodiment, the tuple arrays 261, 262 are arranged as one sequential array containing all of the column partitions in sequence on the same row.

Moreover, in the disclosed CPSM format, a tuple array is structured to include the elements from the vector partition that correspond to a particular column partition (with respect to computations for the SpMV operation) on the same row as their tuples within the tuple array. That is, in the CPSM format, the specific dense vector elements that are needed for computations are logically arranged with (e.g., on the same row) the representation of their corresponding sparse vector elements (e.g., tuples). For example, as previously described, the SpMV operation between sparse matrix 210 and the DCMV 230 involves computations between the element “10” in row c0 of the DCMV 230 (also in row c0 of the vector partition 251) and the elements in column c0 of the sparse matrix 210 (also in column c0 of column partition 241), the element “8” in row c1 of the DCMV 230 (also in row c1 of the vector partition 251) and the elements in column c1 of the sparse matrix 210 (also in column c1 of column partition 241), and the element “6” in row c2 of the DCMV 230 (also in row c2 of the vector partition 251) and the elements in column c2 of the sparse matrix 210 (also in column c2 of column partition 241). Accordingly, by arranging this data in the CPSM format, the tuple array 261 includes the specific elements from the DCMV 230 (or the vector partitions 251-253), namely the list of elements contained in sections 290-292 of the tuple array 261, which particularly correspond to the column partitions 241-243 (or column partition group 247) that are also represented in that tuple array. Additionally, FIG. 2B further illustrates that the elements from the vector partition 251 that correspond specifically to the column partition 241 are on the same row (section 290) as the tuples 270-272 which represent the elements from the column partition 241 (e.g., having a range of three columns) in the tuple array 261. Similarly, the elements from the vector partition 252 that correspond specifically to the column partition 242 are on a row (section 291) with the tuples 273-275 which represent the elements from the column partition 242 (e.g., having a range of three columns) in the tuple array 261; and the elements from the vector partition 253 that correspond specifically to the column partition 243 are on a row (section 292) with the tuples 276-278 which represent the elements from the column partition 243 (e.g., having a range of three columns). As alluded to above, the tuples 270-272 and corresponding to vector partitions 241-243 (depicted as sections 290-292 in the tuple array 261) can all be arranged sequentially on a single row of the tuple array 261.

In this same manner, the tuple array 262 is structured to include: elements from vector partition 254 that correspond specifically to the column partition 244 on a row (section 293) with the tuples 280-282 which represent the elements from the column partition 244 (e.g., having a range of three columns) in the tuple array 262; the elements from the vector partition 255 that correspond specifically to the column partition 245 are on a row with the tuples 283-285 which represent the elements from the column partition 245 (e.g., having a range of three columns); and the elements from the vector partition 256 that correspond specifically to the column partition 246 are on a row as the tuples 286-288 which represent the elements from the column partition 246 (e.g., having a range of three columns).

Therefore, it may be described that a row in a tuple array in the CPSM format has a number of elements from the dense vector that is equal to the number of columns that are included in the defined range of column partitions. In the example of FIGS. 2A-2B, the column partitions 241-246 have a range (or size) of three sequential columns from the sparse matrix 210. Thus, the tuple arrays 261, 262 are structured to consist of row(s) of data, where a row respectively includes tuples 270-278, 280-288 that each represent three consecutive columns from the sparse matrix 210 (or one of the column partition groups 247, 248) and three elements from the DCMV 230 (or vector partitions 251-256).

In an additional embodiment, a sparse matrix that is already in a CSR layout, as described above in reference to FIG. 1, can be reorganized into the optimized CPSM format illustrated in FIG. 2B. According to this embodiment, the sparse matrix 210 can be initially formatted in a CSR layout (example shown in FIG. 1), where the matrix data is represented as a coordinated list of the sparse matrix elements. That is, each element from the sparse matrix 210 is represented as tuples of type (row, column, value) with any elements having a zero value being omitted to compress the data. Therefore, the CSR layout in FIG. 1 only has tuples that correspond to the non-zero values in the sparse matrix. In contrast to the column-partitioning of the disclosed CPSM format, the data in the CSR layout is sorted first by rows. These tuples of type (row, column, value) from the CSR layout can be used as a starting point to reorganize the data into the CPSM format, having tuples that are further arranged into the tuple-array structures illustrated in FIG. 2B. A decision on whether conversion from a CSR layout will be utilized can be application specific, and can be based on various considerations such as uses of the matrix data, the repetition of those uses, tradeoffs between conversion and storage expenses, and the like.

Referring back to FIG. 2B, because the tuple-arrays 261, 262 are in a distinct CPSM format, portions of data needed to perform the SpMV operation can be flexibly distributed throughout the system for multiplication processing by any one of the PEs (or the cores on the PEs) in the system. Stated another way, the CPSM format allows column partitioned sections from the sparse matrix 210 (i.e., column partition groups 247, 248 represented in the tuple arrays 261, 262) and partitioned sections of the DCMV 230 (i.e., vector partitions 251-256 represented in the tuple arrays 261, 262) to be efficiently distributed across the PEs respectively, instead of the using the CSR layout which requires the entire DCMV 230 to be distributed to each PE at the start of the execution before any multiplication can occur.

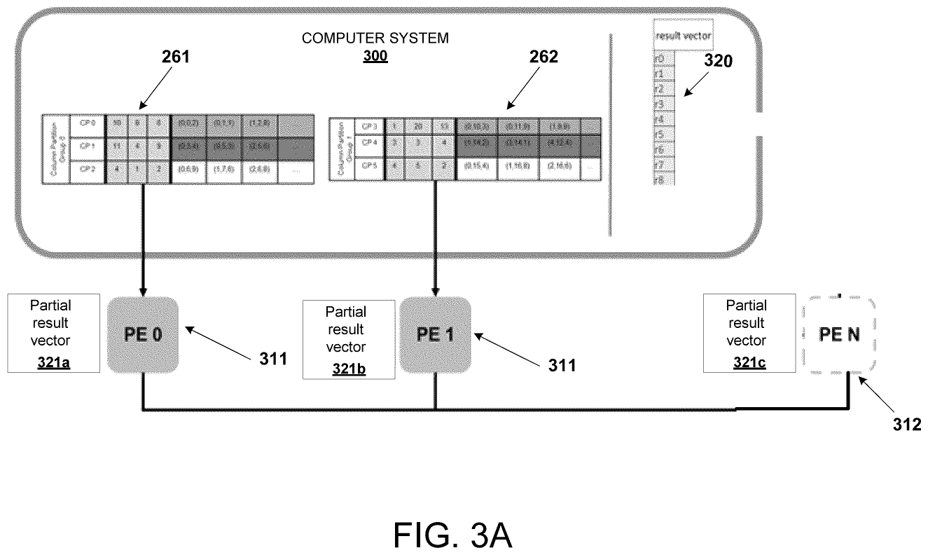

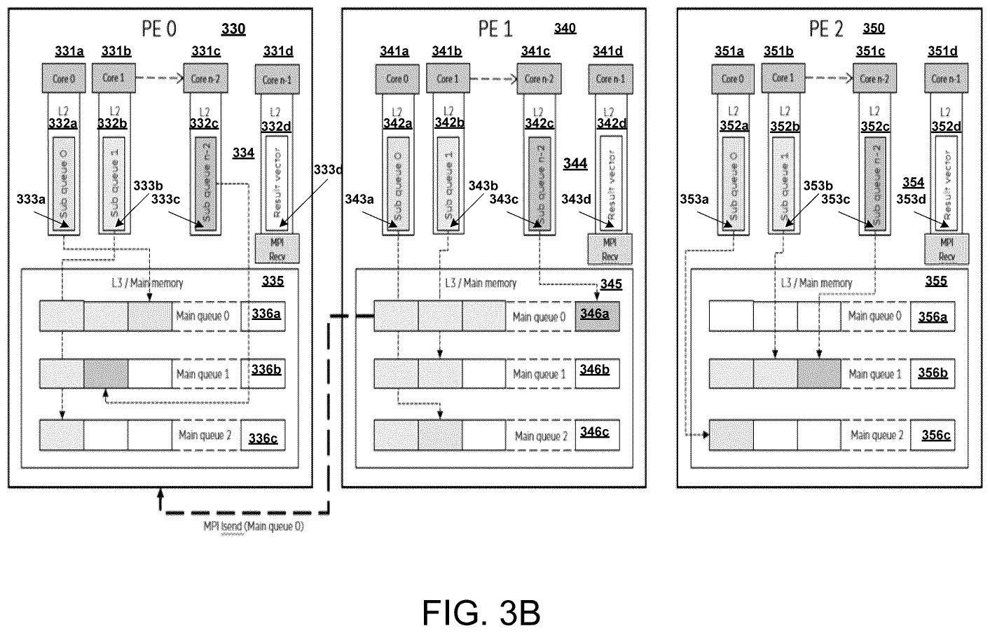

FIG. 3A illustrates an example of a computer system 300 where data in the CPSM format (also illustrated in FIG. 2B) can be leveraged by a distributed computing system for efficient matrix-based processing, for instance during a SpMV operation. As depicted in FIG. 3A, the tuple arrays 261, 262 that are structured in accordance with the CPSM format are distributed across multiple PEs 310-312 to execute the SpMV operation depicted in FIG. 2A. As alluded to above, if n PEs are available on a computer system, then all the system's PEs can be used for compute processing of the SpMV operation. Thus, FIG. 3A illustrates that the computer system 300 can have an architecture that includes a plurality of PEs, depicted as PE 310, PE 311, and a variable number of PEs up to PE 312, where PE 312 is a number n processing entity on the computer system 300 (shown in FIG. 3A as “PE n”). Accordingly, the data in the CPSM format, namely tuple arrays 261, 262, can be partially distributed amongst all of the n numbers of PEs on the computer system 300, shown as PEs 310-312. Subsequently, all of the n PEs on the computer system 300 would execute its respective portion of the compute processing and result accumulation (based on the CPSM data the PE has received) in order to ultimately generate the result vector for SpMV operation.

The computer system 300 is implemented as a distributed computing system having a plurality of PEs, shown as PEs 310-312. As referred to herein, a distributed computer system is a computing environment in which various components of the computer, such as hardware and/or software components, are spread across multiple devices (or other computers). By utilizing multiple devices, shown as PEs 310-312, the computer system 300 can split up the work associated with calculations and processing, coordinating their efforts to complete a larger computational job, particularly the SpMV operation, more efficiently than if a single processor had been responsible for the task. The computer system 300 can be a computing environment that is suitable for executing scientific, engineering, and mathematical applications that may involve matrix operations, namely SpMV operations. For instance, the computer system 300 may be a computer of a file system (controlling operation of a storage device, e.g., disk), high-performance computer, or graphics processing system. It should be appreciated that the architecture for the computer system 300 shown in FIG. 3A serves as an example and is not intended to be limiting. For example, as described above, a computer system including any number of distributed PEs can be utilized to implement matrix operations in accordance with the CPSM format, as disclosed herein.

In the example of FIG. 3A, the computer system 300 has multiple PEs 310-312 (not limited to the number illustrated in the example) that are communicatively coupled to each other (and a main CPU, main memory not shown) for enhanced performance and reduced power consumption. In an embodiment, the PEs 310-312 are implemented as processors, where having several distinct and distributed processors 310-312 in the same computer system 300 enables more efficient simultaneous processing of multiple tasks, such as with parallel processing and multithreading. In particular, the PEs 310-312 can be implemented as multicore processors, where each PE 310-312 respectively includes multiple cores incorporated therein, and internal caches that are connected with a system bus and main memory (not shown). Restated, a general architecture for each of the PEs 310-312 on the computer system 300 can include: multiple cores and a three-level cache hierarchy, with L1 cache(s) and L2 cache(s) being private to a core (or possibly a pair of cores) and L3 cache(s) being shared across all of the cores on the PE. As previously described, the column partitions of the CPSM format can be formed having a size that is based on the size of the L2 caches for the cores on the PEs, in accordance with an embodiment. In an alternative embodiment, the PEs 310-312 can be considered as a core, where the computer system 300 is a multicore processor having multiple cores, namely PEs 310-312, implemented thereon.

In FIG. 3A, data in the CPSM format is distributed across the computer system 300 such that tuple array 261, which includes the data representing column partition group 247, and vector partitions 251-253, is transferred to PE 310, and tuple array 262, which includes the data representing column partition group 248, and vector partitions 254-256, is transferred to PE 311. Furthermore, the data is particularly arranged in the CPSM format to provide a guarantee of independence between the data that is contained within the separate tuple arrays 261, 262. The guarantee of independence can be described as ensuring that each of the per-element computations for elements within a certain tuple array can be completed using data (matrix data and dense vector data) that is present in that tuple array. Thus, the disclosed CPSM format, having this guarantee of independence, allows for prefetching of both matrix data and vector data by the PEs 310, 311 performing the matrix multiplication as they process through the data (of a column partition group) and allows for computation and communication to be overlapped as much as possible throughout the application, greatly helping to reduce overall execution time of the SpMV operation, even as the system size and problem size scale. Moreover, although it is not shown in FIG. 3A, it should be appreciated that if the CPSM data included any additional data, for example more tuple arrays, then that data could also be distributed amongst the remaining available PEs on the computer system 300, such as PE 312.

FIG. 3A also depicts a result vector 320, or DCRV, which is generated as a result of the computer system 300 executing the SpMV operation between the sparse matrix (shown in FIG. 2A) and the DCMV (shown in FIG. 2A). As illustrated in FIG. 3A, the result vector 320 is a 9×1 matrix. Generally, in matrix multiplication, as previously described, the number of columns in the multiplicand matrix (e.g., sparse matrix) must be equal to the number of rows in the multiplier matrix (e.g., dense vector), and the result matrix has the number of rows of the multiplicand matrix (e.g., sparse matrix) and number of columns as the multiplier matrix (e.g., dense vector). Here, in the example of FIG. 3A, the result matrix 320 would have the same number of rows as the 9×18 sparse matrix (shown in FIG. 2A) and the same number of columns as the 18×1 DCMV (shown in FIG. 2A). An entry of the result matrix 320, referred to as RMᵢⱼ, is generally obtained by multiplying term-by-term each element of the entire ith row of the sparse matrix and a corresponding entry in the entire column (jth column) of the DCMV, and summing these n products, where n is less than or equal to 18 in this example. In other words, RMᵢⱼ is the dot product of the ith row of the sparse matrix and the jth column of the DCMV. However, it should be noted, that in the CPSM format, these per-element computations are reduced to only non-zero elements. Therefore, the number of products that need to be summed to derive a RMᵢⱼ in the result matrix 320 are equal to the number of non-zero elements in a row of the sparse matrix.

Thus, in order to derive an RMᵢⱼ entry of the result matrix 320, the computations for non-zero elements in a row of the sparse matrix that are spread across both of the tuple arrays 261, 262 need to be accumulated. That is, the per-element product computations using data from tuple array 261 and the separate per-element product computations using data from tuple array 262 are needed to compute a sum, which is the RMᵢⱼ entry of the result matrix 320. For example, referring back to FIGS. 2A-2B, non-zero elements in row r0 of the original sparse matrix 210 are column-partitioned into both column partition groups 247, 248, where these non-zero elements are represented in both tuple arrays 261 (corresponding to non-zero elements from row r0 in column partition group 247), 262 (corresponding to non-zero elements from row r0 column partition group 248). Consequently, the RMᵢⱼ entry (row r0) of the result matrix 320 that corresponds to the dot product of row r0 of the sparse matrix with the column of the DCMV requires some computations performed by PE 310 and some computations performed by PE 311 be completed in order for the final result, namely the result vector 320, is calculated.

Due to the CPSM format spreading the columns of a sparse matrix across the system 300, vis-à-vis tuple arrays, partial results that correspond to a portion of a row from the sparse matrix (e.g., some elements from a row that are included in a column-partition group) will be generated. In order to calculate a dot product result for an entire row of elements from the sparse matrix (e.g., an element in the result vector), partial results will still need to be accumulated with the partial results corresponding to the rest of the elements in its row (in other tuple arrays).

Generally, each PE that is utilized for SpMV computations will individually generate corresponding partial results (also referred to as result data), where the partial results correspond to the computations for data in a tuple array that is transferred to that particular PE. Further, result data associated with each of the partial results generated from its respective PE will need to be combined (e.g., summed) in order to generate the final result vector for the SpMV operation. In addition, as previously described, the result vector 320 can be partitioned based on the number of PEs that are available on the computer system. Restated, a partial result vector can be maintained respectively by each of the available PEs, where the multiple partial result vectors collectively represent the entire result vector for the SpMV operation. As depicted in FIG. 3A, each of the PEs 310-312 is configured to maintain one of the partial result vectors 321a-321c, which essentially partitions and/or distributes the result vector 320 across all of the PEs of the computer system 300.

By default, all of the computed elements in the row of a column partition will be combined before they are communicated. For instance, the higher the column partition size, the higher the probability that the row will have more non-zero elements in that column partition. Thus, all of the non-zero values in that row will be accumulated, which in-turn leads to lesser addition required by the accumulation core and also less data that is required to be communicated. Furthermore, combining the partial results of the same row from different column partition in a computation node may degrade the performance causes difficulty in predicting when the partial results of the same row from different column partition will be computed. Therefore, sending these partial results to the accumulation core as they are computed will help speed up the process. This also ensure the overlap between computation and communication.

For example, in a case where the total number of available PEs (e.g., n) on the computer system 300 is three, namely PEs 310-312, the result vector 320 can be partitioned such that: PE 310 is configured to maintain partial result vector 321a on its memory; PE 311 is configured to maintain the partial result vector 321b on its memory; and PE 312 is configured to maintain the partial result vector 321c on its memory. Accordingly, as the compute processing for the SpMV operation is distributed across multiple PEs of the computer system 300, the result data from those calculations that are associated with each of the partial result vectors 321a-321c can be transferred to the appropriate one of the PEs 310-312. As an example, as PE 310 executes compute processing for the CPSM data that it has received, which is tuple array 261, that data is processed such that: the result data that is calculated by PE 310 and corresponds to the partial result vector 321a can remain thereon; the result data that is calculated by PE 310 and corresponds to the partial result vector 321b can be communicated to PE 311; and the result data that is calculated by PE 310 and corresponds to the partial result vector 321c can be communicated to PE 312. Compute processing on PE 311 is also conducted in a similar fashion.

In some implementations, elemental partial results corresponding to a result vector row processed within a PE are combined (also referred to as accumulation) before being communicated to the final PE containing the row. In reference to FIG. 3A, this can be described as accumulating all of the result data that is computed at PEs 310, 311, which is associated with one or more of the partial results 321a-321c, before communicating the entire accumulated data to the particular one of the PEs 311-312 that is handling the respective partial result. For example, referring to the previous compute processing example of PE 310, all of result data that is computed by PE's 310 portion of the SpMV operation (e.g., related to the CPSM data distributed thereon) that corresponds to the partial result vector 321b is accumulated (on PE 310) before that data is transferred to PE 311 which is handling partial result vector 321b. Similarly, all of result data that is computed on PE 310 that corresponds to the partial result vector 231c is accumulated (on PE 310) before that data is transferred to PE 312. Doing so reduces the volume of communication to the final PE, but may experience a tradeoff with respect to increased complexity.

In other implementations, combining, or accumulation, of the result data can be done at the column partition, the column partition group or opportunistically as a finite cache where capacity misses are evicted to the final PE. In instances where combining is commutative, the result is independent of what choice is made and is not a key aspect of the embodiments disclosed herein.

In other words, result data associated with all of the partial results, which are individually calculated by each of the PEs as a partial component of the full result, have to be generated and accumulated together at some point in a manner that allows the final result vector for the SpMV operation to be obtained. By accumulating result data for each partial result from each of the PEs that are involved in compute processing, all of these partial components of the result that are distributed across the system (being separately generated at a respective PE) can be amassed and pieced together to generate the full final result for the SpMV operation, namely a result vector (or DCRV).

Referring to the example of FIG. 3A, PE 310 performs the processing associated with the per-element computations of SpMV specially for the tuple array 261. In particular, PE 310 executes multiplication calculations between the elements of the partitioned blocks of the sparse matrix that are represented in tuple array 261 and the elements of the partitioned section of the DCMV that are represented in tuple array 261. Additionally, PE 311 performs the processing associated with the per-element computations of SpMV specifically for the tuple array 262. That is, PE 311 executes multiplication calculations between the elements of the partitioned blocks of the sparse matrix that are represented in tuple array 262 and the elements of the partitioned section of the DCMV that are represented in tuple array 262. Therefore, PE 310 generates a partial result of the SpMV that corresponds the elements in tuple array 261, while PE 311 generates a separate partial result of the SpMV that corresponds to the elements in tuple array 262. Moreover, it is a key aspect of the disclosed embodiments that the distinct arrangement of the data in the CPSM format allows for the processing performed by each of the PEs 311-312 for per-element computations to be enhanced. For instance, the size of the columns in the column partitions of the CPSM format are defined as a function of the L2 cache size of a PE to reduce cache misses, thereby reducing latency and reducing the computation time at each PE (and the overall computation time associated with the full SpMV operation).

Since every PE can compute multiple column partitions, partial results of the same row from different column partitions are typically not accumulated before communicating the partial result to the accumulation core. The compute PE will accumulate the partial computed results of a row in that column partition. Eventually one partial result for ever row in a column partition will be communicated.

As previously described, a key aspect of the disclosed CPSM format is to partition the sparse matrix and the dense multiplier vector, which enables the parallel processing capabilities of a distributed computer system, such as computer system 300, to be leveraged in order to separate the various computations needed to execute a SpMV operation amongst the processing power of the PEs 310-312. However, this distributed and parallelized processing, which enhances efficiency of the SpMV operation in some respects (e.g., efficient cache utilization, and improved scalability) does require the additional processing associated with accumulation, as the result vector is also distributed across the PEs (each PE has a partial result for the result vector).

To address the need to accumulate the multiple partial results that are output by the distributed PEs, a specialized procedure for handling the SpMV operation utilizing the CPSM format is also disclosed. In the disclosed handling procedure, computer system resources are dedicated to handling the accumulation (and summation) of each partial result. Where each partial result is individually computed by a respective PE in a manner that properly derives the full dot product results for each row and the sparse matrix (and the column of the DCMV). According to the embodiments, the PEs on the computer system support threads for executing the specialized procedure for accumulating (and summing) result data for partial results that represent the full result for the SpMV operation utilizing the disclosed CPSM format. As a result, the full result of the SpMV operation is partitioned across many physical nodes, and partial results can be sourced by any PE. Furthermore, as previously described, accumulating the result data for a particular partial result within a PE before communicating this data to the partial result's final location reduces internode communication. Consequently, to this point, the number of PEs that can be involved in both compute processing for the SpMV and accumulation can be n, where n is the total number of available distributed PEs in the computer system, thereby allowing each of the PEs to be more equally loaded to reduce overall completion time.

In some embodiments, each of the PEs 310-312 of computer system 300 can have at least one thread (processing core) that is dedicated to result accumulation. For example, PEs will have a condition denoting all threads have processed all CPSM groups required of it for a particular partial result which triggers flushing any remaining data for the partial result to their final PE (e.g., PE handling the particular partial result vector) for accumulation. Likewise, all PEs with result vector partitions, shown in FIG. 3A as partial result vectors 321a-321c, will have a condition denoting all elements of the vector are globally visible.

FIG. 3B depicts an example internal architecture of PEs 330, 340, 350 that may comprise a computer system executing an SpMV operation using the CPSM format disclosed herein, for example the computer system shown in FIG. 3A. As seen in FIG. 3B, each of the PEs 330, 340, 350 include a plurality (e.g., n number) of cores 331a-331d, 341a-341d, and 351a-351d, respectively. Each of the cores 331a-331d, 341a-341d, and 351a-351d are shown in FIG. 3B as having a respective L2 cache 332a-332d, 342a-342d, and 352a-352d. Also, each of the cores 331a-331d, 341a-341d, and 351a-351d respectively have a private sub queue, shown as sub queues 333a-333d, 343a-343d, and 353a-353d.

FIG. 3B illustrates that a result vector for the SpMV operation can be partitioned amongst all of the PEs 330, 340, 350, as each PE has at least one of their respective sub queues maintaining a partial element of the result vector (also referred to herein as a partial result vector). Particularly, FIG. 3B shows sub queue 333d of PE 330 including result vector 334, sub queue 343d of PE 340 including result vector 344, and sub queue 353d of PE 350 including result vector 354. Additionally, each of the PEs 330, 340, 350 have an L3/main memory 335, 345, 355, respectively. Further, each L3/main memory 335, 345, 355 includes several main queues 336a-336c, 346a-346c, and 356a-356c, respectively. Each of the PEs 330, 340, 350 has a number of main queues 336a-336c, 346a-346c, and 356a-356c that equals to the number of PEs (available of the computer system). In this example, since there are three PEs 330, 340, 350, each PE has three main queues 336a-336c, 346a-346c, 356a-356c thereon, where a main queue is responsible for maintaining data for the partial result vector held by a corresponding PE. In the example of FIG. 3B, main queues 336a, 346a, 356a hold data associated with PE 330 and result vector 334; main queues 336b, 346b, 356b hold data associated with PE 340 and result vector 344; and main queues 336c, 346c, 356c hold data associated with PE 350 and result vector 354.

Also, FIG. 3B illustrates an example of how data can be stored and transfer between the PEs 330, 340, 350, for example during an SpMV operation using the CPSM format disclosed herein. For example, while each of the cores 331a-331d, 341a-341d, and 351a-351d performs computations for the SpMV operation, their corresponding buffers, shown as sub queues 333a-333d, 343a-343d, and 353a-353d, fill up with the data association with these computations. Once one of the local sub queues 333a-333d, 343a-343d, and 353a-353d is filled to capacity, the data is pushed to the appropriate one of the main sub queues 336a-336c, 346a-346c, and 356a-356c. For example, FIG. 3B illustrates that while core 331b is executing multiplication of values and fills up its local sub queue 333b corresponding to PE 350, its data is sent to main sub queue 336c because it can identify that this particular data is part of the partial result 354 that is being held by PE 350.

Further, as one of the main sub queues 336a-336c, 346a-346c, and 356a-356c fills up, the data is communicated to the appropriate one of the PEs 330, 340, 350. For example, FIG. 3B illustrates that, once filled, main queue 346a of PE 340 (which holds data corresponding to PE 330), sends its data to PE 330. Core 331d on PE 330 is dedicated to maintaining its corresponding portion of the result vector, namely result vector 334. Thus, when the data sent by PE 340 (vis-à-vis main queue 346a) is received by PE 330, this data can be accumulated with the result data that has already been computed and included in result vector 334 by core 331d. In this manner, the computational load for a SpMV operation can be distributed across the PEs 330, 340, 350 as each of the PEs are actively involved in multiplication computation and accumulation of the result vector.

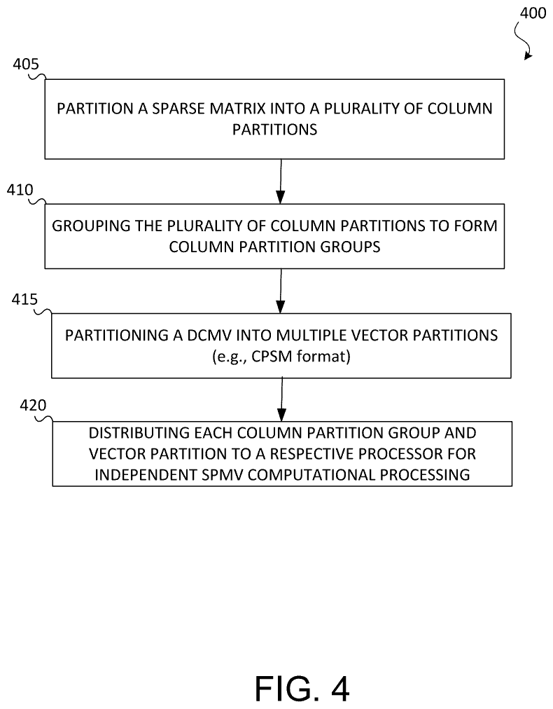

Referring now to FIG. 4, a process 400 is illustrated for implementing the column-partitioning aspects for reorganizing data from a sparse matrix and a dense vector associated with a matrix operation, such as SpMV, into the CPSM format, as disclosed herein. Process 400 can be considered as a column-wise domain decomposition, where this column-partitioning of the sparse matrix serves as the building blocks for the CPSM format. In an example, the process 400 can be performed by a main CPU of a computer system that is executing the SpMV operation, as used in scientific, engineering, and mathematical applications in a computing environment such as file systems, high-performance computers, graphics processing systems, and the like. In an embodiment, the computer system implementing the process 400 is a distributed computer environment having a plurality of distributed PEs, for example shown in FIG. 3. Utilizing several PEs and the disclosed CPSM format can both be leveraged in order to separate the multiple computations needed for the SpMV operation into smaller and parallelized processing tasks executed by each PE in an efficient and optimized manner.

The process 400 can begin at operation 405, where a sparse matrix is partitioned into a plurality of column partitions. The sparse matrix can be an M×N sparse matrix that is the multiplicand in the SpMV operation. Further, the SpMV operation can include a dense vector, also referred to as a DCMV, which is structured as N×1 vector that is the multiplier in the SpMV operation. In operation 405, the elements of the sparse matrix can be partitioned by column, forming a plurality of smaller column-partitioned blocks that include a number of columns from the original sparse matrix.

The number of columns that are included in a column partition, or column-partitioned blocks of elements, is referred to as the size. The size for column partitions can be predefined, for example being set as a static parameter at deployment, or dynamically selected, for example being set at run-time when performing the SpMV operation. In accordance with the embodiments, the size is defined as a function of the L2 cache size (for a PE) of the computer system. By using memory, specifically L2 cache size, as a limitation that governs how the column-partitioned data is organized in the CPSM format, this ensures that that all of the data needed for the computations (e.g., elements within the same set of columns of the sparse matrix) processed by a respective PE will be consecutively stored in its cache, thereby reducing cache misses, and improving the overall computational speed of the SpMV operation by the computer system. Furthermore, in an embodiment, the number of column partitions (or the number of column partition groups) and/or the size of the column partitions generated by operation 405 is based on other specifications of the computing resources in addition to (or in lieu of) the L2 cache size, such as the number of non-zero elements of the sparse matrix (e.g., column partitions are of equal size.

Thus, after operation 405, the sparse matrix has been effectively reduced by reorganizing the sparse matrix data into several smaller blocks, namely column partitions, that can be efficiently distributed across the PEs in the system. Stated another way, the elements contained in all of the smaller column partitions generated in operation 405 can collectively be considered the larger original sparse matrix.

Next, at operation 410, the process 400 groups several individual column partitions (resulting from previous operation 405) together, in order to form multiple distinct column partition groups. A column partition group is a collection of multiple contiguous, by column, column partitions. Thus, each column partition group comprises a column-partitioned monolithic block of elements from the original sparse matrix. Transferred an entire column partition group, including several individual column partitions, to a PE allows a group of data, which is larger than the individual column partitions, to distributed in the system in a manner that better optimize the balance between the number of transfers needed against the size of data processed (e.g., amount of computational processing time) by each PE. As previously described, as each column partition group includes one or more column partitions, a group only includes a portion of entire row from the original sparse matrix. According to an embodiment, the number of column partition groups (or the number of column partitions included in each column partition group) formed in operation 410 are based on the number of vector partitions and/or the number of PEs used for the distributed compute processing.

The process 400 can continue to operation 415 to partition the DCMV into multiple distinct vector partitions. A critical aspect of the CPSM format involves also partitioning the dense vector, namely the DCMV, in addition to column-partitioning the sparse matrix in the previous operations 405, 410. In operation 415, the dense vector is row-partitioned into multiple smaller and distinct partition vectors, where each partition vector has fewer elements and rows than the full DCMV. Thus, by partitioning the DCMV into smaller and sperate blocks allows, the dense vector data can also be distributed across the PEs (with the column partition groups) in a scalable and efficient manner for parallelized compute processing. Consequently, process 400 performs an efficient partitioning and distributing of the dense vector (as smaller vector partition blocks) that is distinct from conventional approaches that have to recreate the full dense vector multiple times, for each PE used in parallelization, which leads to inefficiencies and bottlenecks (e.g., poor scalability, and inefficient consumption of space, memory, and processing resources).

In an embodiment, the number of vector formed in operation 415 are based on the number of column partition groups and/or the number of PEs used for the distributed compute processing. Thus, a vector partition is a smaller subset block of contiguous elements, by row, from the original DCMV.

In addition, operation 415 can include formatting the column partition groups and the vector partitions as tuple arrays, in accordance with the CPSM format. Tuple arrays are a defined as a data structure that includes a sequenced list of tuples of type (row, column, value) which represent the non-zero elements from the column partition groups, and the elements from the vector partition. Tuple arrays also are particularly structured to logically arrange a specific column partition group with its corresponding vector partition, where correspondence is based with respect to per-element computations needed for SpMV. This ensures that each tuple array, which is used in the CPSM format, includes the specific elements from the dense vector, or DCMV (without including the entire DCMV), that are needed to perform a SpMV computation for each element in the corresponding column partition group (from the sparse matrix) that is represented in that tuple array.

Moreover, as previously described, organizing the elements in the column partition groups (from the sparse matrix) into tuple arrays of the CPSM format reduces and/or compresses the amount of data that needs to be transferred to the PEs by only representing the non-zero elements. Additional details regarding the structure and contents of tuple arrays, in accordance with the disclosed CPSM format, are described above, for example in reference to FIG. 2B) and are not described again in detail for purposes of brevity. Thus, after operation 415, the sparse matrix and the DCMV are reorganized into the CPSM format and can be efficiently distributed to the PEs.

Subsequently, process 400 can proceed to operation 420 where data in the disclosed CPSM format, namely the tuple arrays including the column partition groups and the vector partitions, are distributed to a respective processor, or PE for parallelized processing. In an embodiment, the computer system executing the SpMV operation has multiple PEs that are designated for compute processing associated with the SpMV operation and result accumulation associated with the SpMV operation. Further, the number of separate tuple arrays may be equal to the number of compute PEs. Thus, for example, each tuple array in the CPSM format can be transferred to a separate compute PE. The computational and result accumulation operations performed by the distributed PEs to execute the SpMV operation, using the data in the CPSM format, is previously disclosed in detail, for example in reference to FIG. 3. Therefore, the particular details describing the computations, calculations, and accumulation involved in each PE's processing to complete the SpMV operation and generate a final result vector are not described again in detail for purposes of brevity.

By utilizing the CPSM format, parallelized processing capabilities of the distributed PEs can be leveraged such that the SpMV operation as a whole is distributed across the multiple PEs in the computer system, where each PE can independently perform a portion of the SpMV compute processing using only the data in its respective tuple array. The data in the disclosed CPSM format is also particularly organized such that PEs access and process this data in a manner that also dramatically improves scalability and improves computational efficiency (e.g., reduced data transferred, reduced cache misses, reduced computation time).

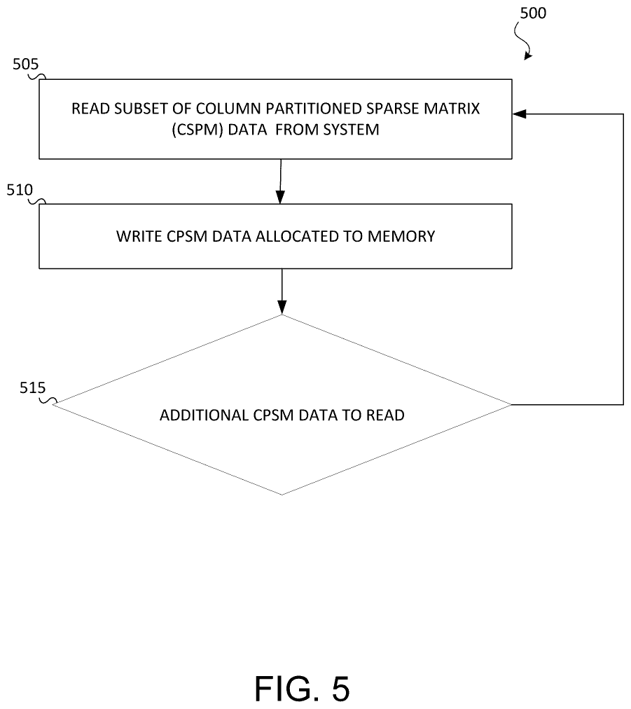

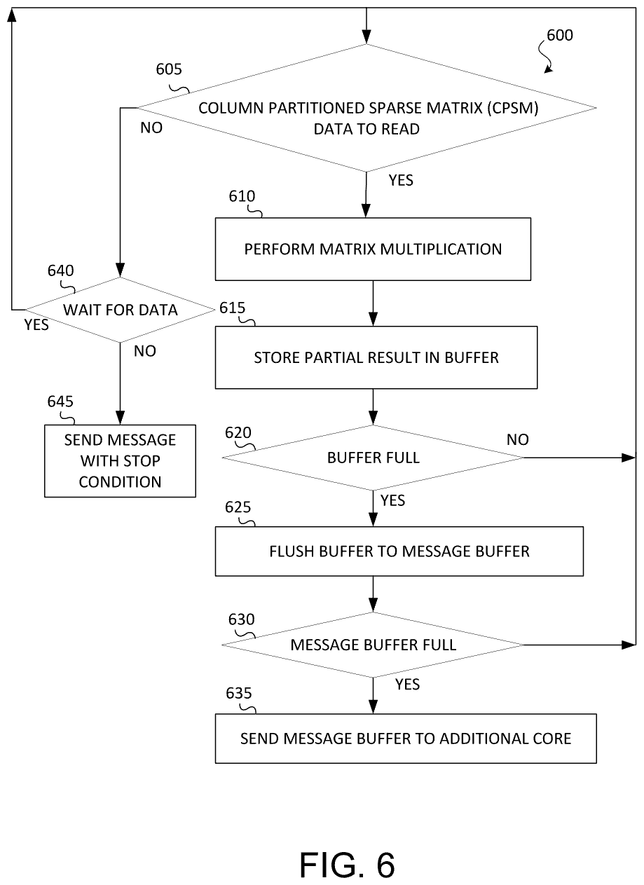

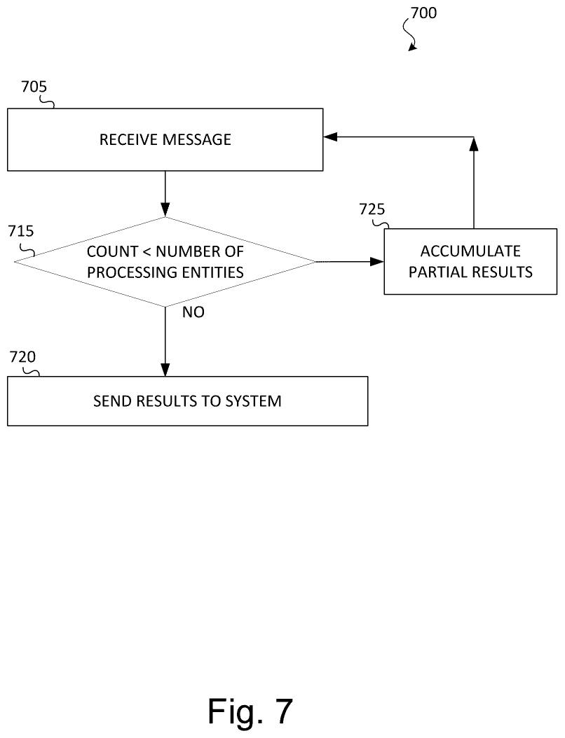

The disclosed CPSM format, and the parallelized distributed processing associated with the SpMV operation using this data, does require a specialized procedure for accumulating the final DCRV result. That is, each PE only has a partial result for the SpMV operation due to only portions of the compute processing being distributed across the multiple PEs. In other words, each partial result that is individually processed by each has to be accumulated and properly compiled together in order to derive the full final DCRV result. The specialized procedure for executing the SpMV computations and result accumulation, utilizing data in the disclosed CPSM format, is depicted by FIGS. 5-7. In an embodiment, each of the processes of FIGS. 5-7 can by implemented by a respective thread. For example, as all of the PEs of the computer system can be involved in compute processing and result accumulation, all of the PEs have the capability to execute the separate threads that individually correspond to perfecting, depicted in FIG. 5, compute, depicted in FIG. 6, and result accumulation, depicted in FIG. 7.

As a general description of the coordination between the processes in FIGS. 5-7, all of the PEs are dedicated to receiving and accumulating partial results sent from the other PEs in the system. Thus, all PEs are dedicated to compute processing involving multiplication, storing partial results, sending partial results, and making occasional prefetching calls. The row coordinate of a CPSM element also defines the index of the result vector, DCRV, to which the partial result will be multiplied, and because the result vector is partitioned by rows across the system it also indicates the destination of the messages as the matrix is processed.

FIG. 5 depicts a process 500 that can implement a prefetching thread that is used to efficiently access, or fetch, data in the CPSM format. The process 500 starts at operation 505 that reads subsets of data associated with a SpMV operation in the CPSM format, from the system. For example, the computer system can have stored thereon (e.g., main CPU) data organized in the disclosed CPSM, which includes column-partitioned blocks of data from the sparse matrix, namely column partition groups, and partitioned blocks of the dense matrix. These subsets of data can be placed in the CPSM format during a pre-processing procedure (depicted in FIG. 4), and then transferred to respective PEs, where a thread executing on the PE reads this data.

Next, at operation 510, the CPSM data that is read during previous operation 505 can be allocated to memory. In some cases, the memory is local to the PE receiving the CPSM data, such as a L2 cache for a core.

Subsequently, at operation 515, the process 500 can perform a check to determine whether there is any additional CPSM data that can still be read from the computer system. In the case where there is remaining CPSM data (indicated by “Yes” in FIG. 5), the process returns to operation 505. As illustrated in FIG. 5, the process 500 can be considered as an iterative procedure, where operations 505-515 are subsequently re-executed for a number of subsequent iterations until the process 500 ends. Process 500 iteratively continues to read data at operation 505, and then allocate that read data to memory at operation 510, until operation 515 determines that there is no remaining CPSM data to be read.

Returning back to operation 515, in the case where there is no remaining CPSM data (indicated by “No” in FIG. 5), this indicates that all of the CPSM data associated with the SpMV operation on the system has been retrieved, or fetched, and the process 500 ends. Process 500 is considered as pre-fetching as the data can be read and allocated to memory in the background before the PE actually begins processing this data, for instance when performing the compute processing associated with the SpMV operation.

Referring now to FIG. 6, a process 600 is depicted that implements a compute thread that performs the per-element calculations associated with SpMV operation on data in the CPSM format. For example, a PE executing the process 600 can include two buffers that each partially computed result element passes through. There is a large message buffer that exists outside of the L2 cache for each partition of the result vector, and an independent smaller temporary buffer in its L2 cache for storing partial results as it processes down different row ranges for each column partition. The process 600 is structured to encourage retention of the large message buffer in the L3 cache and message sizes are chosen to allow for this as execution permits.

Because different row ranges correspond to different partitioned sections of the DCRV this means that as a column partition is processed, it can more efficiently store partial results in its L2 cache buffer and more efficiently write the partial results to their respective destination message buffer in L3 cache/DRAM in batches as the matrix data is processed. This allows the multiplication threads to efficiently fetch CPSM data from memory to perform the multiplication and amortize the overhead of moving the partial results both out of the PE's core and out of the PE to be aggregated. This organization also allows for all cores in a PE to contribute to adding to a message before it is sent out, allowing the overhead for all messages to be amortized efficiently across all cores.

Process 600 can begin at operation 605, where a conditional check is performed to determine whether there is CPSM data to be read. As previously described, data in the CPSM format includes column-partitioned blocks from the sparse matrix, namely column partitions, and partitioned blocks for the dense vector, or DCMV. In the case where there is CPSM data to be read (indicated as “Yes” in FIG. 6) the process 600 continues to operation 610. Alternatively, in the case that operation 605 determines that there is no CPSM data to read (indicated in FIG. 6 as “No”) the process 600 goes to operation 645 to wait for data. After a defined wait time has expired, the process 600 can go to operation 645 to send a message with a stop condition.

At operation 610, matrix multiplication is performed. For example, operation 610 involves the per-element calculations between a partial row of elements in a column partition group and the elements from the portion of the DCMV that are represented in the same tuple array in the CPSM format.

Subsequently, at operation 615, the partial result generated by executing the matrix multiplication in previous operation 610 is stored in a buffer. As an entire row from the sparse matrix is distributed across all of the PEs, the matrix multiplication performed by an individual PE only corresponds to the per-element calculations for a portion of a row, or a partial result. Matrix multiplication of operation 610 can involve partially calculating an entry of the result matrix, RMᵢⱼ, by multiplying term-by-term each element of the entire ith row of the sparse matrix and a corresponding entry in the entire column (jth column) of the DCMV (the summing of these n products is performed by the result accumulation process in FIG. 7). In other words, an element in the result matrix RMᵢⱼ is the dot product of the ith row of the sparse matrix and the jth column of the DCMV. Previous operation 610 for an individual PE at least performs the multiplication of elements in a portion of a row in the sparse matrix with the corresponding elements in a portion of the DCMV and generates this partial result that is stored in a buffer in operation 615. A partial result may be stored in the buffer after the matrix multiplication computations for each and every element in the CPSM data at the PE is completed. Alternatively, partial result may be continuously stored in the buffer after the matrix multiplication computations for one or more elements in the CPSM data at the PE is completed, with the partial result being updated in the buffer as the computations continues for the remaining elements.

The process 600 continues to operation 620 to perform a conditional check in order to determine whether the buffer, which is storing partial results, is full. In the case that operation 620 determines that the buffer is full (indicated in FIG. 6 by “Yes”) the process 600 moves to operation 625. Alternatively, in the case that operation 620 determines that the buffer is not full (indicated in FIG. 6 as “No”) the process 600 returns to operation 605, where operation 605-620 are performed iteratively until it is determined that the buffer is full.

At operation 625, the data within the buffer (e.g., L2 cache), namely the partial result computed by the individual PE, is flushed to a message buffer. Thereafter, at operation 630, a conditional check is performed in order to determine whether the message buffer is full. In the case that operation 630 determines that the message buffer is full (indicated in FIG. 6 as “Yes”) the process 600 proceeds to operation 635. Alternatively, in the case that operation 630 determines that the message buffer is not full (indicated in FIG. 6 as “No”) the process 600 returns to operation 605, where operation 605-630 are performed iteratively until it is determined that the message buffer is full. In some cases, the partial result buffer may get filled up quickly due to the small size (e.g., these buffers will be flushed to message buffer frequently). Thus, in these cases, process 600 can return to operation 610 for efficiency.

Subsequently, at operation 635, a message is sent to the additional core in the PE, and the process 600 ends. In some cases, message buffer will also get filled up many times over the execution of the application, so whenever it gets filled up, it will send the entire message buffer to the appropriate PE and the message buffer can be reutilized. Accordingly, in these scenarios, once the message buffer is sent in operation 635, the process 600 can then go to either operation 610 if there is still data to process, or it can go to operation 605 to check if there is any remaining CPSM data to process. Consequently, the operation 600 computes and communicates a partial result for the SpMV, corresponding to the CPSM data it has retrieved, to other cores and/or PEs in the system. According to the embodiments, the compute process 600 can be executed by multiple PEs of the computer system in parallel, which leverages the parallelization capabilities of the distributed computing environment and improves processing efficiency.

Referring now to FIG. 7, a process 700 is depicted that implements a thread that performs result accumulation functions associated with SpMV operation on data in the CPSM format. As previously described, all PEs available on a computer system can be involved in compute processing and result accumulation for a SpMV operation, thus process 700 (and the associated thread) can be executed by each of the PEs.

Process 700 can begin at operation 705 where a message is received. The message can be received from another PE (or core), where the message is indicative of the partial result associated with the SpMV operation that has been computed by the respective PE. For example, during computations, every PE will send data from the message buffer to the appropriate PE as it gets filled. Thus, over the course of execution, many messages from a PE can be received. In every message from a PE there will be a flag indicating whether that specific message will be the last message to be received from a particular PE. If this flag is present, and this is a last message from a specific PE, then it will increase a count.

Thereafter, at operation 715, a conditional check is performed to determine whether a current count is less than the total number of PEs on the computer system. In the case that operation 715 determines that the count is not less than (e.g., equal to, or greater than) then the total number of distributed PEs (indicated in FIG. 7 as “No”) then this indicates that the last message from the last PE has been received, and that all of the PEs that are involved in the distributed SpMV computations, and having CPSM data thereon, have completed their respective partial result.

Thus, the process can continue to operation 720. Alternatively, in the case that operation 715 determines that the current count is still less than (e.g., equal to, or greater than) the total number of distributed PEs (indicated in FIG. 7 as “Yes”) the process moves to operation 725, where the data received for a partial result is accumulated with the data for that partial result that has already been computed and compiled. Restated, a PE may maintain a specific partial result of the DCRV, and the PE can continue receiving and accumulating result data for this partial result as additional computations continue being performed on the distributed PEs. Thus, operation 725 performs a summation calculation needed for the dot product multiplication of the entire row from the sparse matrix with the column of the DCMV, from the partial results that correspond to a portion of the row that has been distributed across the PEs in the system. Thus, as a partial result is maintained at a PE, operation 715 can accumulate additional computational results from other PEs to continuously generate more elements of the partial result, and the result vector, DCRV. Subsequently, process 700 can go back to operation 705, iteratively performing the sub-process of operations 705-715 until it is determined that all of the data for a partial result has been received from each of the compute PEs.

After the process 715 has accumulated all of the data for a partial result from the other distributed PEs (and all of the PEs in the computer system have completed accumulated their respective partial results) the full result of the SpMV operation is obtained. That is, each element in the result vector has been calculated, and the full result vector, DCRV, has been generated. Thus, the process 700 allows result accumulation and matrix multiplication to occur in parallel, rather than in two independent phases as the result vector accumulation and computation for an SpMV operation is divided and distributed computed across multiple PEs.

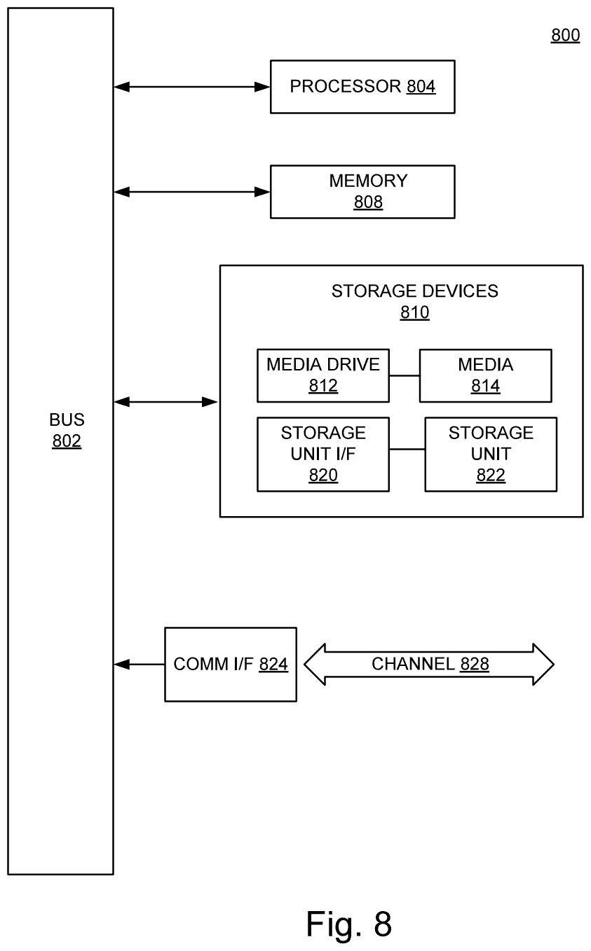

FIG. 8 depicts an example computer system 800 that can perform a series of executable operations for implementing the CPSM formatting and matrix operations (e.g., SpMV), as disclosed herein. The computer system 800 may be executing engineering, scientific, and graphic applications that implement matrix operations, namely SpMV, as an essential kernel. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random-access memory (RAM), cache and/or other dynamic storage devices, coupled to bus 802 for storing information and instructions to be executed by processor 804. Main memory 808 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes storage devices 810 such as a read only memory (ROM) or other static storage device coupled to fabric 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 516, such as a mouse, a trackball, or cursor direction keys for communicating direction information and command selections to processor 804 and for controlling cursor movement on display 812. In some implementations, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative implementations, hard-wired circuitry may be used in place of or in combination with software instructions.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
partitioning, by column, one or more contiguous columns of a sparse matrix of data into a plurality of column partitions, wherein the sparse matrix is associated with a sparse matrix vector multiplication operation;
grouping the plurality of column partitions to form a plurality of column partition groups; and
distributing each of the plurality of column partition groups to a respective processor from a plurality of processors such that a portion of the sparse matrix vector multiplication operation is independently performed by each processor of the plurality of processors.

2. The method of claim 1, further comprising:
generating a representation of only each of the non-zero elements within the column partition group.

3. The method of claim 2, wherein the representation of the non-zero elements comprises a tuple.

4. The method of claim 3, wherein the tuple comprises at least: a row, a column, and a value.

5. The method of claim 2, wherein a size of the column partition is defined based on resource characteristics of a computer system.

6. The method of claim 5, wherein the resource characteristic comprises an L2 cache size associated with the plurality of processors.

7. The method of claim 2, wherein a size of a column partition group is based on a number of the plurality of processors.

8. The method of claim 4, further comprising:
partitioning a dense column multiplication vector to form multiple vector partitions, wherein the sparse matrix vector multiplication operation is executed between the sparse matrix and the dense column multiplication vector.

9. The method of claim 8, further comprising:
generating a tuple array representation corresponding to each column partition group from the plurality of column partition groups, wherein each tuple array comprises the tuple representation for the corresponding column partition group and a corresponding vector partition from the multiple vector partitions.

10. The method of claim 9, wherein the corresponding vector partition within in the tuple array comprises elements from the dense column multiplication vector that correspond to the elements of the column partition group within the tuple array with respect to matrix multiplication.

11. The method of claim 10, wherein distributing each of the plurality of column partition groups comprises transferring each tuple array to a respective processor from the plurality of processors, wherein the respective processor is utilized for compute processing associated with the sparse matrix vector multiplication operation.

12. The method of claim 11, wherein each respective processor from the plurality of processor computes data corresponding to a partial result of the sparse matrix vector multiplication operation.

13. The method of claim 12, wherein each of the plurality of processors maintains a corresponding partial result and accumulates data for the corresponding partial result from each respective processor from the plurality of processors.

14. The method of claim 13, wherein a result vector is represented by all of the partial results maintained on each respective processor from the plurality of processors, the result vector is the result of the sparse matrix vector multiplication operation.

15. The method of claim 1, wherein each of the plurality of processors comprises a plurality of cores computing data corresponding to the partial result of the sparse matrix vector multiplication operation.

16. A system comprising:
a plurality of processors executing a sparse matrix vector multiplication operation (SpMV) using data formatted in accordance with a column-partition sparse matrix (CPSM) format, wherein a result vector associated with the SpMV operation is partitioned amongst each of the plurality of processors and each of the plurality of processors comprises:
a plurality of cores, one core of the plurality of cores maintaining a partial result vector of the result vector associated with the SpMV operation and the other cores of the plurality of cores executing computations for the SpMV operation to generate partial results; and
an L3 main memory.

17. The system of claim 16, wherein each the plurality of cores comprises an L2 cache memory, the L2 cache memory of the one core of the plurality of cores maintains the partial result vector and the L2 cache memory of the other cores of the plurality of cores maintains partial results associated with the computation executed by the respective core.

18. The system of claim 17, wherein for each of the plurality of processors, the L3 main memory maintains partial results associated with each of the partial result vectors, each partial result vector being maintained on a separate processor of the plurality of processors.

19. The system of claim 18, wherein partial results corresponding to a partial result vector in the L3 main memory of a processor is communicated to the processor among the plurality of processors that is maintaining the corresponding partial result vector.

20. A non-transitory computer-readable storage medium having stored thereon executable computer program instructions that, when executed by one or more processors, cause the one or more processors to perform operations comprising:
partitioning, by column, one or more contiguous columns of a sparse matrix of data into a plurality of column partitions, wherein the sparse matrix is associated with a sparse matrix vector multiplication operation;
grouping the plurality of column partitions to form a plurality of column partition groups; and
distributing each of the plurality of column partition groups to a respective processor from a plurality of processors such that a portion of the sparse matrix vector multiplication operation is independently performed by each processor of the plurality of processors.
